(19) United States
(12) Patent Application Publication
(10) Pub. No.: US 2008/0148162 A1
(43) Pub. Date: Jun. 19, 2008

(54) Device for Providing User Interface According to Markup-Language Document

(75) Inventor: CHIUN-FENG HSIAO, Hsinchu (TW)

Correspondence Address: WPAT, PC, 7225 BEVERLY ST., ANNANDALE, VA, 22003, US

(73) Assignee: VICOTEL, INC., Hsinchu (TW)

(21) Appl. No.: 11/743,747

(22) Filed: May 3, 2007

(30) Foreign Application Priority Data
Dec. 15, 2006 (TW) 095147006

(51) Int. Cl. G06F 3/00; G06F 17/00

(52) U.S. Cl. 715/760; 715/234

(57) ABSTRACT

The present invention provides a device for providing a user interface according to a markup-language (ML) document. A storage medium is provided in the device. The device is installed with an operating system, a first software and a second software. The operating system executes the first software, so that the first software provides a user interface according to a ML language, the user interface is used to generate a trigger to the first software. Based on the trigger, the first software then generates a request. The second software achieves communication with a remote computer based on the request so as to exchange multimedia data therebetween.

### BACKGROUND OF THE INVENTION

1. Field of the Invention

The present invention generally relates to user interfaces, and more particularly to a device for providing a user interface according to a markup-language (ML) document.

2. Description of the Prior Art

Markup languages used by World Wide Web (WWW) documents nowadays involve the use of tags to express various elements, such as texts and graphics, so as to let a web browser know how to display these elements to users. Markup languages also use tags to inform the web browser on how to respond to the actions of the users, one such action is, for example, clicking of a mouse for connection.

As computer and network technologies evolve, documents that use markup languages are no longer static documents. For example, by employing Dynamic HyperText Markup Language (DHTML) and applets, HTML documents are able to interact with network users or produce various dynamic effects. Moreover, users are able to enter text information into a text block of the HTML document and send this text information by clicking a button element.

However, due to security reasons, markup-language (ML) documents do not have the authority to access local system resources. For example, after a ML document is downloaded via a network to a local computer, the document is prohibited to access files originally stored in a hard drive of the local computer, so as to prevent damage to the data in the local computer.

In order to enhance the functions of the markup-language documents and strengthen services that can be provided by WWW websites, ML documents are now able to access system resources by introducing a verified ActiveX element. For example, if a ML document wishes to temporarily store data or install a program in the hard drive of the local computer, it enquires the user to see if he/she trusts the verification of this ActiveX element. If so, the ML document may then access the system resources of the local computer.

Although this technique allows the ML documents to access the system resources of the local computers, it nonetheless possesses several shortcomings. First, ActiveX requires extra verification procedures, which brings inconvenience when used. Second, ActiveX is not executed at the local computer by a mechanism such as an Application Program Interface (API), but operates independently after being downloaded. Thus, it requires confirmation from the user based on security concerns each time it is used, and cross platform is harder to achieve.

In addition, on a desktop of an ordinary information device, for example, a “Windows” operating system developed by Microsoft, a standard shell allows users to drag program links/shortcuts to change the desktop arrangement, and allow users to select their own pictures and color as the desktop background.

However, traditional standard shells can only provide the functionality of desktop modification, failing to satisfy the customized requirements of various kinds of home appliances. Furthermore, standard shells are not suitable for application software environment of vertical markets or consumer markets that are application specific, for example, a medical information device desktop in a hospital or an administrative information device desktop in the public sector. Tools for customizing the desktops are of course being developed, but developers need to re-compile the whole shell after a new desktop is completed, which is very inefficient and inconvenient.

Moreover, a method for providing a customized desktop using webpage concept has been developed, but the shell of a webpage desktop is limited in that it must be completely in compliance with the standard shells. Also, a traditional task bar program is not compatible with the standard shells. Therefore, the prior-art technique has deficiency that needs to be overcome.

### SUMMARY OF THE INVENTION

In view of the background and the needs in the industry, the present invention provides a device for providing a user interface according to a ML language that solves the problems of the prior art.

The device for providing a user interface according to a ML language provided by the present invention is capable of calling local software and controlling other software using the user interface.

In order to achieve the above objective, the present invention provides a device for providing a user interface according to a ML language, comprising a storage medium, wherein the device is installed with an operating system, a first software and a second software. The operating system executes the first software, so that the first software provides a user interface according to a ML language, the user interface is used to generate a trigger to the first software. The first software generates a request based on the trigger.

Based on the request, the operating system loads the second software into a memory and executes the second memory, so that the second software receives the request and makes a communication with a remote computer based on the request, the remote computer receives the request via the communication and exchanges multimedia data with the second software via a wireless communication protocol based on the request, wherein the second software can be used to execute the multimedia data, or the storage medium can store the multimedia data.

Another objective of the present invention is to reduce system development cost, avoid modifications and re-compiling of shells and make the task bar program compatible with the shell, increasing ease of application and system compatibility.

### BRIEF DESCRIPTION OF THE DRAWINGS

The accompanying drawings incorporated in and forming a part of the specification illustrate several aspects of the present invention, and together with the description serve to explain the principles of the invention. In the drawings:

FIGS. 1A and 1B are structural schematic diagrams of an embodiment of the present invention; and

FIGS. 2A and 2B are structural schematic diagrams of another embodiment of the present invention.

### DETAILED DESCRIPTION OF THE PREFERRED EMBODIMENTS

The present invention is directed to a device for providing a user interface according to a markup-language (ML) document. Detailed steps and constituents are given below to assist in the understanding the present invention. Obviously, the implementations of the present invention are not limited to the specific details known by those skilled in the art of the device for providing a user interface according to a ML document. On the other hand, well-known steps or constituents are not described in details in order not to unnecessarily limit the present invention. Detailed embodiments of the present invention will be provided as follow. However, apart from these detailed descriptions, the present invention may be generally applied to other embodiments, and the scope of the present invention is thus limited only by the appended claims.

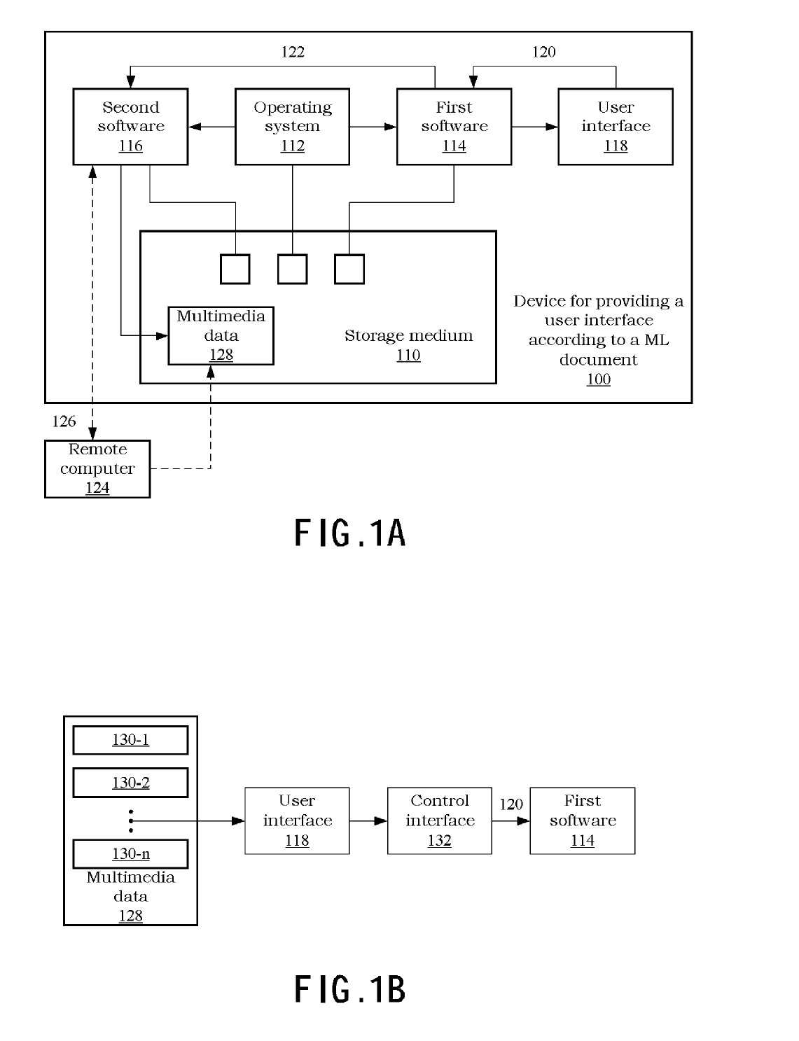

According to an embodiment of the present invention, as shown in FIG. 1A, the present invention provides a device 100 that provides a user interface according to a markup-language (ML) document. The device 100 includes a storage medium 110. The storage medium 110 is installed with a plurality of software comprising an operating system 112, a first software 114 and a second software 116.

The abovementioned operating system 112 executes the first software 114, such that the first software 114 provides a user interface 118 according to a ML document. The user interface 118 is used to generate a trigger 120 to the first software 114, which then generates a request 122 in response to this trigger 120.

The abovementioned operating system 112 then loads the second software 116 to a memory and executes the second software 116 based on the above request 122. Thereby, the second software 116 receives the request 122 and achieves a communication 126 with a remote computer 124 based on this request 122. The remote computer 124 receives the request 122 via this communication 126, and exchanges multimedia data 128 with the second software 116 via a wireless communication protocol based on this request 122. The multimedia data 128 can be played by the second software 116 or stored in the storage medium 110.

The multimedia data 128 contains a ML document, as shown in FIG. 1B. The ML document includes at least one Universal Resource Locator (URL) 130 document. The user interface 118 can be used to select at least one URL 130 so as to generate the trigger 120 to the first software 114. More particularly, the at least one URL 130 document is used to render a control interface 132 to the user interface 118. By selecting the control interface 132, a trigger 120 corresponding to the at least one URL is generated to the first software 114.

In addition, the multimedia data 128 may include a document, an image, a voice and the second software 116. When the multimedia data 128 is the second software 116, the second software 116 can be used to execute the multimedia data 128. The above document may include XML (Extensible Markup Language), XLink, Namespace, DTD, Schema, CSS, XHTML or HTML (HyperText Markup Language).

The exchange of the multimedia data 128 can be made through, for example, http (hypertext transmission protocol), FTP (File Transfer Protocol), VoIP (Voice over Internet Protocol), VoIM (Voice over Instant Messenger), Telnet or Gopher.

The above multimedia data contains a ML document, which includes at least one URL document. The user interface is used to select a URL document so as to generate a trigger to a browser.

The above multimedia data can not only be a video file or a ML document, but can also a document or application software. The above document may include XML, XLink, Namespace, DTD, Schema, CSS, XHTML or HTML.

The above exchange of the multimedia data can be made through http, as well as FTP, VoIP, VoIM, Telnet or Gopher.

The present invention further provides a recording medium with a user interface program stored therein, in order to provide control of other software, the user interface program makes a computer to function as the following devices:

a device for executing a first software according to a ML document to provide a user interface;

a device for allowing the user interface to provide a trigger to the first software;

a device for executing the first software and generating a request based on the trigger;

a device for loading a second software into a memory and executing the second software based on the request;

a device for executing the second software and receives the request by the second software;

a device for executing the second software so as to achieve a communication with a remote computer based on the request.

a device for controlling the second software to exchange multimedia data with the remote computer via the communication based on the request, wherein the multimedia data is exchanged according to a wireless communication protocol, and the exchange of the multimedia data can be made through http, FTP, VoIP, VoIM, Telnet or Gopher, wherein the multimedia data includes a ML document comprising at least one URL document;

a device for allowing the user interface to generate the trigger based on the URL document;

a device for storing the multimedia data in a storage medium; and

a device for playing the multimedia data using the second software.

Moreover, the above multimedia data also includes a document, an image, a voice and the second software. The above document may include XML, XLink, Namespace, DTD, Schema, CSS, XHTML or HTML.

The above exchange of the multimedia data can be made through http, as well as FTP, VoIP, VoIM, Telnet or Gopher.

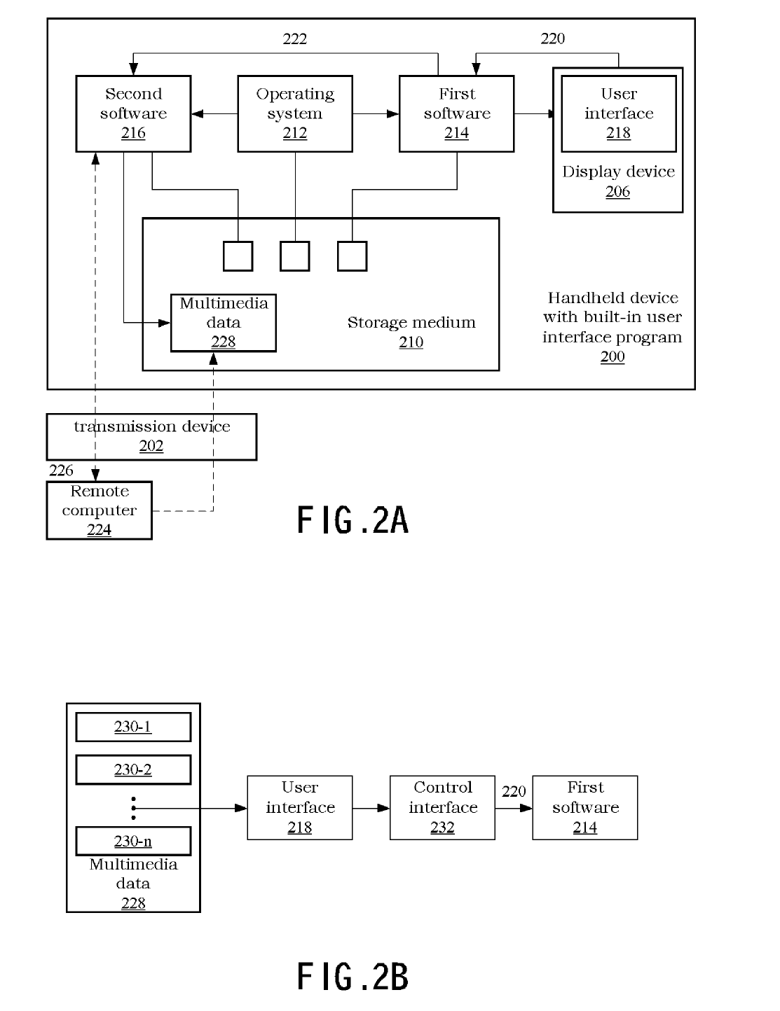

According to another embodiment of the present invention, as shown in FIG. 2A, the present invention provides a handheld device 200 with a built-in user interface program. The device 200 includes a transmission device 202, a display device 206 and storage medium 210. The storage medium 210 is installed with a plurality of software, comprising an operating system 212, a first software 214 and a second software 216.

The abovementioned operating system 212 executes the first software 214, such that the first software 214 provides a user interface 218 according to a ML document on the display device 216. The user interface 218 is used to generate a trigger 220 to the first software 214, which then generates a request 222 in response to this trigger 220.

The abovementioned operating system 112 then loads the second software 216 into a memory and executes the second software 216 based on the above request 222. Thereby, the second software 216 receives the request 222 and achieves a wireless communication 226 with a remote computer 224 through the transmission device 202 based on this request 222. The remote computer 224 receives the request 222 via this communication 226, and exchanges multimedia data 228 with the second software 216 via the transmission device 202 based on this request 222, wherein the second software 216 executes the multimedia data 228.

The multimedia data 228 contains a ML document, as shown in FIG. 1B. The ML document includes at least one Universal Resource Locator (URL) 230 document. The user interface 218 is used to select at least one URL 230 so as to generate the trigger 220 to the first software 214. More particularly, the at least one URL 230 document is used to render a control interface 232 to the user interface 218. By selecting the control interface, a trigger corresponding to the at least one URL is generated to the first software.

In addition, the multimedia data 228 may include a document, an image, a voice and the second software 116. When the multimedia data 228 is the second software 216, the second software 216 can be used to execute the multimedia data 228. The above document may include XML, XLink, Namespace, DTD, Schema, CSS, XHTML or HTML.

The above handheld device with a built-in user interface program may include an operating system, a browser (first software) and local application software (second software) installed in the above storage medium. The browser provides a user interface via a screen (display device) according to a ML document. The browser includes at least one selection, which upon selecting triggers the browser to generate a request.

The operating system then loads the local application software into a memory and executes the local application software based on this request. The local application software then receives the request and makes a wireless network connection (communication) with a remote computer based on this request. The remote computer receives the request via the wireless network connection, and the remote computer exchanges a video file or another application software with the local application software via http based on this request (i.e. exchange the multimedia data with the second software via the wireless communication protocol, wherein the multimedia data includes the second software), wherein the local application software may play this video file immediately online or execute the another application software online; or the video file or the another application software can be stored in the storage medium before the video file is played by the local application software or the another application software is executed by the browser.

Moreover, the local application software can be a local network. The local network is used to receive the above request and provide and display a digital data on the above display device based on the request, or makes a wireless network connection with the remote computer based on the request so as to exchange the above video file or another application software, thus achieving the above request.

It is obvious from the above descriptions of the embodiments that the present invention may comprise various modifications and differences. Thus, the scope of the appended claims should be comprehended, such that the present invention can be broadly applied to other embodiments apart from the above detailed descriptions. The above are only preferred embodiments of the present invention, they are not intended to limit the claims of the present invention. Those equivalent modifications and changes without departing from the spirit disclosed by the present invention are within the scope of the following claims.

1. A recording medium with a user interface program stored therein, in order to provide control of other software, the user interface program makes a computer to function as the following devices:
a device for executing a first software according to a markup-language (ML) document to provide a user interface;
a device for allowing the user interface to provide a trigger to the first software;
a device for executing the first software and generating a request based on the trigger;
a device for executing a second software and receiving the request by the second software;
a device for executing the second software so as to make a communication with a remote computer based on the request;
a device for controlling the second software to exchange multimedia data with the remote computer via the communication based on the request; and
a device for playing the multimedia data using the second software.

2. A recording medium with a user interface program stored therein of claim 1, further comprising, in order to provide control of other software, making the computer to function as a device for loading the second software into the memory and executing the second memory based on the request.

3. A recording medium with a user interface program stored therein of claim 1, further comprising, in order to provide control of other software, making the computer to function as a device for storing the multimedia data into a storage medium.

4. A recording medium with a user interface program stored therein of claim 1, wherein the communication exchanges the multimedia data via a wireless communication protocol.

5. A recording medium with a user interface program stored therein of claim 1, wherein the exchange of the multimedia data is achieved by one selected from the group consisting of http, FTP, VoIP, VoIM, Telnet and Gopher.

6. A recording medium with a user interface program stored therein of claim 1, wherein the multimedia data comprises the ML document, the ML document comprises at least one Universal Resource Locator (URL) document.

7. A recording medium with a user interface program stored therein of claim 6, further comprising, in order to provide control of other software, making the computer to function as a device for allowing the user interface to generate the trigger according to the at least one URL document.

8. A recording medium with a user interface program stored therein of claim 7, wherein the at least one URL document is used to render a control interface to the user interface, and the trigger to the first software is generated by selecting the control interface corresponding to the at least one URL document.

9. A recording medium with a user interface program stored therein of claim 1, wherein the multimedia data comprises at least one selected from the group consisting of a document, an image, a voice and the second software.

10. A recording medium with a user interface program stored therein of claim 9, wherein when the multimedia data is the second software, the second software is used to execute the multimedia data.

11. A recording medium with a user interface program stored therein of claim 9, wherein the document is at least one selected from the group consisting of XML, XLink, Namespace, DTD, Schema, CSS, XHTML and HTML.

12. A device for providing a user interface according to a ML document, comprising:
a transmission device;
a display device; and
a storage device installed with a plurality of software, the plurality of software comprising:
an operating system;
a first software, the operating system executing the first software so that the first software displays the user interface on the display device according to the ML document, wherein the user interface is used to generate a trigger to the first software, the first software generating a request based on the trigger; and
a second software, the operating system executing the second software so that the second software receives the request and makes a wireless communication with a remote computer via the transmission device based on the request, the remote computer receiving the request via the communication, and exchanging a multimedia data with the second software through the transmission device based on the request, wherein the second software plays the multimedia data.

13. A device for providing a user interface according to a ML document of claim 12, wherein the operating system loads the second software into a memory and executes the second software based on the request.

14. A device for providing a user interface according to a ML document of claim 12, wherein the storage medium is used to store the multimedia data.

15. A device for providing a user interface according to a ML document of claim 12, wherein the exchange of the multimedia data is achieved by one selected from the group consisting of http, FTP, VoIP, VoIM, Telnet and Gopher.

16. A device for providing a user interface according to a ML document of claim 12, wherein the multimedia data comprises the ML document, the ML document comprises at least one Universal Resource Locator (URL) document, the user interface is used to select the at least one URL document so as to generate the trigger to the first software.

17. A device for providing a user interface according to a ML document of claim 16, wherein the at least one URL document is used to render a control interface to the user interface, and the trigger to the first software is generated by selecting the control interface corresponding to the at least one URL document.

18. A device for providing a user interface according to a ML document of claim 12, wherein the multimedia data comprises at least one selected from the group consisting of a document, an image, a voice and the second software.

19. A device for providing a user interface according to a ML document of claim 12, wherein when the multimedia data is the second software, the second software is used to execute the multimedia data.

20. A device for providing a user interface according to a ML document of claim 12, wherein the document is at least one selected from the group consisting of XML, XLink, Namespace, DTD, Schema, CSS, XHTML and HTML.
